(19) United States
(12) Patent Application Publication
(10) Pub. No.: US 2021/0258507 A1
(43) Pub. Date: Aug. 19, 2021

(54) METHOD AND SYSTEM FOR DEPTH-BASED ILLUMINATION CORRECTION

(71) Applicant: TransEnterix Surgical, Inc., Morrisville, NC (US)

(72) Inventors: Tal Nir, Haifa (IL); Kevin Andrew Hufford, Cary, NC (US)

(21) Appl. No.: 17/099,757

(22) Filed: Nov. 16, 2020

Related U.S. Application Data
(60) Provisional application No. 62/935,580, filed on Nov. 14, 2019.

(51) Int. Cl. H04N 5/243; H04N 5/235; H04N 13/254; H04N 13/133

(52) U.S. Cl. CPC H04N 5/243; H04N 5/2351; H04N 2013/0081; H04N 13/133; H04N 13/254

(57) ABSTRACT

A system for correcting illumination in an image includes a light source positioned to illuminate scene points and a camera positionable to capture images of the scene points. The system determines a distance between each of a plurality of scene points and the light source, computes an enhanced light compensated image of the plurality of scene points, and displaying the enhanced light compensated image on an image display.

This application claims the benefit of U.S. Provisional Application No. 62/935,580, filed Nov. 14, 2019, which is incorporated herein by reference.

### BACKGROUND

The light intensity from a light source, measured at a point, is inversely proportional to the square of the point's distance from the light source. Thus, the intensity of light measured at a first point that is twice the distance from the light source as a second point would be one-quarter of that of the second point. FIGS. 2A and 2B are left and right images of a scene as captured by a stereo camera, using a light source positioned close to the camera point. As can be seen, scene points that are further from the light source appear less bright than those closer to the light source. FIGS. 3A and 3B show the scene as a distance map, and illustrates the relative distances between the various items in the scene and the light source.

Some existing types of compensation for such variations in brightness are described in U.S. Pat. No. 6,914,028, and in Chen et al, Illumination Compensation and Normalization for Robust Face Recognition Using Discrete Cosine Transform in Logarithm Doman, IEEE Transactions on Systems, Man, and Cybernetics—Part B: Cybernetics, Vol. 26, No. 2, April 2006 (each of which is incorporated by reference). Many existing types of compensation are solely image-based. For example, gamma correction is a form of correction in which can improve the visualization, but it is not based on a physical model and range, and it therefore provides inferior image quality results. FIGS. 4A and 4B show the left and right images of FIGS. 2A and 2B after simple gamma correction (Gamma=0.3).

Images captured using a laparoscopic or endoscopic camera during medical procedures typically utilize a small illumination source close to the scene, and therefore the displayed images from such cameras can suffer from lack of uniform illumination, with regions of the body cavity positioned further from the illumination source appearing less bright than those in shallower regions. This application describes systems and methods for adjusting the brightness of regions of an image by taking into account the distance between points imaged in those regions and the light source. By correcting based, at least in part, on that distance using principles described in this application, images having more uniform brightness are generated, as is depicted in FIGS. 5A and 5B.

### BRIEF DESCRIPTION OF THE DRAWINGS

FIG. 1 is a block diagram illustrating an exemplary system for depth-based illumination compensation;

FIGS. 2A and 2B are left and right images of a scene as captured by a stereo rig using a light source positioned close to the camera point;

FIGS. 3A and 3B are left and right estimated distance maps of the scene shown in the images of FIGS. 2A and 2B;

FIGS. 4A and 4B are left and right images after simple gamma correction (Gamma=0.3), of the scene shown in the images of FIGS. 2A and 2B.

FIGS. 5A and 5B are left and right images of the scene shown in the images of FIGS. 2A and 2B after depth dependent light compensation emulating light from infinity.

FIG. 6A is a visual display of an image captured using a laparoscopic camera.

FIG. 6B shows the image displayed in FIG. 6B following correction of the image using principles described herein.

### DETAILED DESCRIPTION

When a scene is illuminated by light source relatively close to the scene, the illumination on the scene varies significantly with the distance between the light source and each scene point observed by the camera. At an ideal illumination, the light source is far away, or many light sources are spread at a variety of locations, so that each scene point receives a similar amount of light. This arrangement gives the observer an easier understanding of the fine details of the scene at close and far locations similarly. The concepts described in this application make use of a depth camera in a system that corrects the close light-source problem by first estimating the distance to each scene point, and then compensating for the amount of light arriving at each scene point using image post-processing. The result is a displayed image that ideally emulates use of a light source at infinity and that eliminates the illumination differences due to distance variations between scene points and the light source.

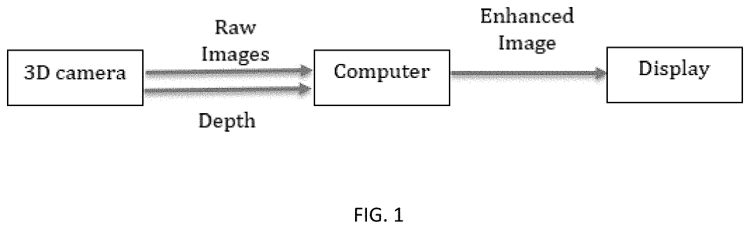

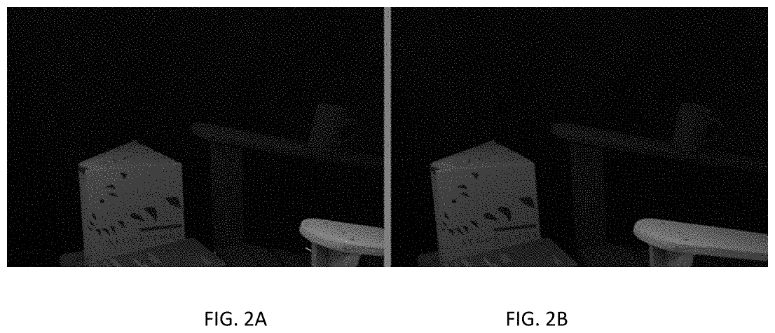

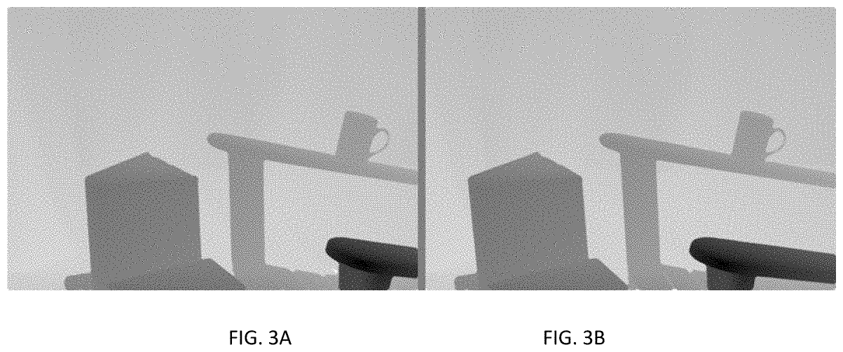

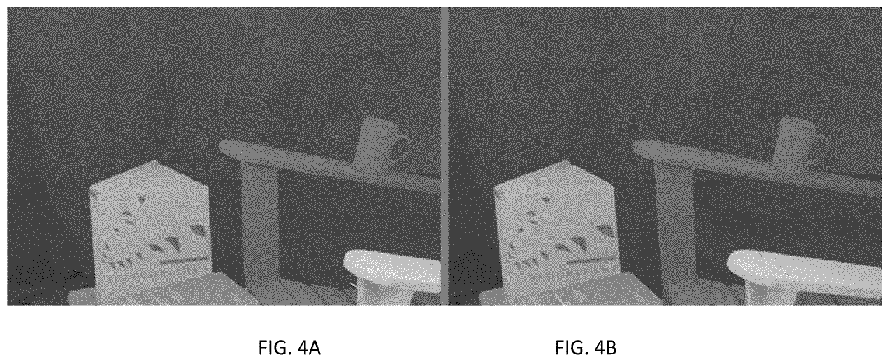

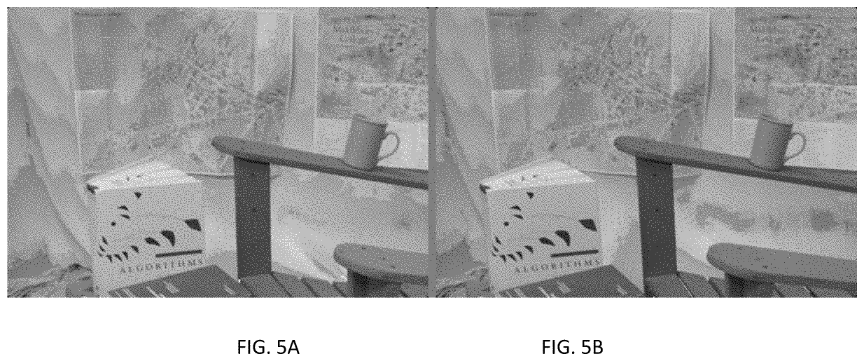

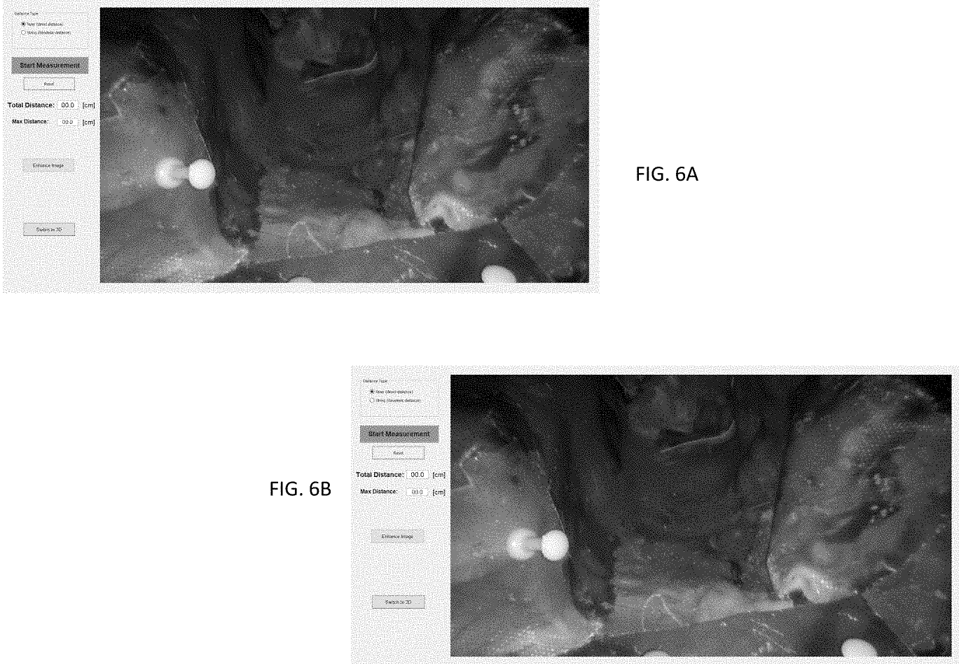

The system, as depicted in FIG. 1, comprises:

1. A 3D camera and a light source

2. Computing unit receiving the images/video from the camera, producing the enhanced image and projecting it on the screen/s

3. An algorithm for computing the depth (if not done on the camera hardware), i.e. the distance between the light source and the scene points captured by the image, which in the case of a laparoscope or endoscope are points within a body cavity using data from the camera. It should be noted that in most cases the arrangement of the light source and image sensor on most endoscopic cameras is such that the distance between the light source and a scene point is equal to the distance between the camera sensor and the scene point, or any differences are either negligible or may be accounted for in the algorithm.

4. An algorithm for computing the enhanced light compensated image to be displayed.

5. A display used for displaying the enhanced image/s

The 3D camera consists of a pair of cameras (stereo rig), or structured light-based camera (such as Intel RealSense™ camera). The depth is either processed in the computer block or inside the camera, depending on the type of the camera.

Certain configurations also include one or more user input devices. When included, a variety of different types of user input devices may be used alone or in combination. Examples include, but are not limited to, eye tracking devices, head tracking devices, touch screen displays, mouse-type devices, voice input devices, switches, movement of an input handle used to direct movement of a component of a surgical robotic system, and/or manual or robotic manipulation of a surgical instrument having a tip or other part that is tracked using image processing methods when the system is in an input-delivering mode, so that it may function as a mouse, pointer and/or stylus when moved in the imaging field, etc. Input devices of the types listed are often used in combination with a second, confirmatory, form of input device allowing the user to enter or confirm (e.g. a switch, voice input device, button, icon to press on a touch screen, etc., as non-limiting examples).

In many systems and methods making use of the concepts described herein, the compensation algorithm is one in which illumination correction is inversely proportional to the depth.

### First Embodiment

As one specific example, the illumination correction algorithm increases the brightness using the inverse square law. A specific case of a point light source attached and moving with the camera at close proximity, in this case, the amount of light radiated on each image pixel is inversely proportional to the square of the distance from the camera (almost the same as the distance to the light source), by estimating the depth, we can generate a Distance\hat{ }2 illumination correction function in order to produce an image emulating light source at infinity (neglecting atmospheric light decay and interference), thus compensating for the illumination differences on close and far scene points.

This example is typical for a laparoscopic camera, where the light source is close to the camera and both move rigidly. It is also typical for a surveillance camera at dark environments, where the illumination is on the camera (in the visible or IR range).

If we write the distance between the illumination source and each scene point as the minimum distance Rmin (Rmin>0) and a difference from this minimum dR (dR>0):

Distance=Rmin+dR

Then the factor of illumination decay with distance would be:

$$Illumination = \frac{C}{D i s t a n c {e}^{2}} = \frac{C}{{( R min + d R )}^{2}} = \frac{C}{R {min}^{2} {( 1 + d R / R min )}^{2}}$$

If the light source is very far away (The sun lighting the earth surface for example), then dR<<Rmin meaning dR/Rmin<<1 and therefor can be neglected and the illumination radiating on each scene point is the same.

However, if the light source is relatively close to the scene, then large variations in the amount of light radiating on different scene points at different distances will be evident, this can be compensated and reversed if we estimate the distance from the light source to each scene point (or to the camera if the light source is very close to the camera), by multiplying each scene point brightness by Distance\hat{ }2

### Additional Embodiments

In some cases, the distance squared correction function described as the first embodiment may be determined to be too aggressive of an illumination correction function. Thus, illumination correction may be applied in a variety of alternative ways.

Proportionality-based correction functions may be linear, logarithmic, exponential, or stepwise/discontinuous. This correction may be applied across the entire displayed image, or may be applied only to certain portions of the displayed image. In other cases, this correction may be applied only in areas in which the scene points lie beyond a certain, controllable, distance threshold.

The system may automatically determine the mode, region, or extent of illumination correction that is applied. In other implementations, the user may confirm the system's recommendations as to regions for which to provide correction (for example, the system may display regions for which correction is recommended, and prompt the user to give input to the system accepting or rejecting the recommendation using a user input device). In other implementations, the user may directly define the areas in which to provide correction via a variety of user input means. For example the user may use a user input device to “click” on an area to be corrected, or to highlight, apply a selection mask to, or “draw” a perimeter around an area s/he wishes to correct, and then (if needed by the system's particular user interface) use confirmatory input to confirm the primary input to the system (e.g. after drawing a perimeter around an area using an instrument tip as a stylus, activating a switch to signal to the system that correction should be performed within the encircled area). The user might also be prompted to confirm whether the extent of illumination correction in the image or in a particular area is acceptable to the user, corrected too much, or not corrected enough.

In some implementations, the illumination correction may be implemented by analysis of the local lighting level across the image or relative to overall image exposure. Nearest-neighbor calculations with moving windows across the image may be used to determine the lighting levels and provide illumination correction.

In other implementations, the illumination correction provided by local lighting level analysis is combined with the illumination correction provided from depth information.

In some implementations, the illumination correction may be paired with other factors, including the use of computer vision, so as to generate an image for display that appears more natural than an image might appear if generated using illumination correction without taking into the causes of other variations in the image data. This may include, but is not limited to: edge recognition, shadow recognition, specularity recognition, as well as light source modeling. In addition to stereo vision, shadow cues are important in providing depth cues, so the amount of correction may be adjusted to retain shadow cueing information while still providing valuable illumination correction.

A light source may vary circumferentially about its longitudinal axis, especially if, like on a laparoscope, the optical fibers carrying the light to the tip only emanate at the sides, or are arranged around the tip in a C-shape. Also, light sources will drop off from its center toward its edge. These dropoffs in intensity are described as a beam angle and a field angle. In some cases, this dropoff may be more gradual or more severe due to lens design or diffusion used. Knowledge of this light source, its shape, and its light falloff characteristics may be incorporated into a modeling algorithm to create a more accurate correction on the surface. This knowledge may be a priori or inferred from the light characteristics on the abdominal surface, or may be inferred from an image captured during white balance calibration.

In some implementations, this may be performed via a surgical robotic system, with the enhanced accuracy, user interface, and kinematic information (e.g. kinematic information relating to the location of instrument tips being used to identify sites at which measurements are to be taken) used to provide more accurate information and a more seamless user experience.

This invention may be used in a laparoscopic case with manual instruments, or in a robotically-assisted case. It may also be used in semi- or fully-autonomous robotic surgical procedures.

All patents and applications referred to herein, including for purposes of priority, are incorporated herein by reference.

We claim:

1. A system for correcting illumination in an image, comprising:
a light source positioned to illuminate scene points;
a camera positionable to capture images of the scene points;
at least one processor and at least one memory, the at least one memory storing instructions executable by said at least one processor to:
determine a distance between each of a plurality of scene points and the light source; and
computing an enhanced light compensated image of the plurality of scene points; and
an image display for displaying the enhanced light compensated image.

2. The system of claim 1, wherein the camera is a 3D camera.

3. The system of claim 2, wherein the 3D camera is a stereo camera or a structured light camera.

4. The system of claim 1, wherein instructions to compute the enhanced light compensated image include a function in which illumination correction for a scene point is inversely proportional to the distance determined for that scene point.

5. The system of claim 4, wherein the function multiples the scene point brightness by the square of the distance for that point.

6. The system of claim 4, wherein the function is a linear, logarithmic, exponential, stepwise or discontinuous function.

7. A system for correcting illumination in an image, comprising:
a light source positioned to illuminate scene points;
a camera positionable to capture images of the scene points;
at least one processor and at least one memory, the at least one memory storing instructions executable by said at least one processor to:
analyze a local lighting level across areas of the image;
compute an enhanced light compensated image of the plurality of scene points; and
an image display for displaying the enhanced light compensated image.

8. The system of claim 7, wherein the function utilizes a nearest-neighbor calculation with moving windows across the image.
